(19) United States
(12) Patent Application Publication
(10) Pub. No.: US 2026/0077301 A1
(43) Pub. Date: Mar. 19, 2026

(54) INTEGRATED MEMBRANE SEPARATION UNIT

(71) Applicant: COMPACT MEMBRANE SYSTEMS, INC., New Castle, DE (US)

(72) Inventors: Robert Daniel LOUSENBERG, New Castle, DE (US); Sudipto MAJUMDAR, New Castle, DE (US)

(21) Appl. No.: 19/104,049

(22) PCT Filed: Aug. 21, 2023
(86) PCT No.: PCT/US2023/030696

§ 371 Date: Feb. 14, 2025

Related U.S. Application Data
(60) Provisional application No. 63/399,905, filed on Aug. 22, 2022.
(60) Provisional application No. 63/408,546, filed on Sep. 21, 2022.
(60) Provisional application No. 63/426,083, filed on Nov. 17, 2022.

(51) Int. Cl. B01D 53/22; B01D 69/02; B01D 71/28

(52) U.S. Cl. CPC B01D 53/229; B01D 53/226; B01D 53/228; B01D 69/02; B01D 71/28; B01D 2256/10; B01D 2257/504; B01D 2325/36

(57) ABSTRACT

Disclosed herein is an integrated membrane separation unit having improved separation performance and incorporating a membrane module incorporating a hydrophilic membrane, a heat transfer module, and a sweep module containing water and water vapor. The sweep module can be configured to supply a sweep stream containing water vapor from derived from the water to a permeate side of the membrane module. The temperature of the water can be maintained though contact with the heat transfer module and heat transfer from an incoming gas stream or a humid feed stream to the water.

### CROSS REFERENCE TO RELATED APPLICATIONS

This application claims the benefit of priority to U.S. Provisional Applications 63/399,905 filed on Aug. 22, 2022; 63/408,546 filed on Sep. 21, 2022; and 63/426,083 filed on Nov. 17, 2022.

### BACKGROUND

Gas streams at low partial pressures that contain carbon dioxide (CO₂) and water vapor are produced in large-scale industrial processes that include energy production and the manufacture of construction materials such as cement and steel. For example, mixtures of CO₂ with mostly nitrogen (i.e., flue gases) and water vapor are produced from steam methane reforming (SMR) to produce hydrogen, and from the combustion of hydrocarbons for electricity generation. Mixtures of CO₂ and water vapor with mostly nitrogen or air are produced from the manufacture of cement and steel and is a significant fraction of all industrial CO₂ emissions. Separation processes incorporating membranes can be used to separate a permeable component such as CO₂ from a less permeable component such as nitrogen for subsequent sequestration. In general, a membrane separation can achieve a high purity of the permeable component by combining multiple connected separation modules with the use of recycle streams. However, prior separation processes can suffer from high energy costs associated with significant compression and/or recycle of large-volume gas streams that have been necessary for separation and recovery of most of the permeable component from the gas stream.

### SUMMARY

The present disclosure addresses the unmet need for a membrane separation that operates at relatively low pressures (i.e., ≤10 atm) and can separate and recover some or most of a permeable component (e.g., CO₂) using a hydrophilic membrane. In some cases, the systems and methods described herein can maintain or increase permeance while maintaining separation selectivity out to higher stage cut.

Useful membranes may include hydrophilic membranes that reversibly absorb and contain water, which may facilitate the permeance of a permeable component that is relatively water-soluble (e.g., CO₂) from a feed stream comprising humidity versus a less permeable component (e.g., N₂). Certain hydrophilic membranes may also incorporate functionality that reversibly interacts with the permeable component in the presence of water, increasing its solubility and permeation. For example, reversible interaction of CO₂ with an (e.g., amine-based) functionality may improve the separation selectivity (separation efficiency) of the hydrophilic membrane under certain operating conditions. Some such membranes can be referred to herein as “facilitated transport membranes”.

The inventors recognized that a drawback to using a hydrophilic membrane is that the water vapor in a humid feed stream is highly permeable and can be more permeable than the permeable component. A high water-vapor flux at a high stage cut can decrease the water content in the hydrophilic membrane, decreasing permeance of the permeable component thereby decreasing the separation selectivity.

As described herein, the aforementioned problems are solved by using a gaseous sweep stream comprising water vapor (e.g., that has a similar or higher water vapor pressure than the humid feed stream) to reduce the water-vapor flux and help maintain a higher water content in the hydrophilic membrane. Heat transfer from an incoming gas stream or the humid feed stream can be used to maintain a water temperature and a corresponding partial pressure of water vapor in the sweep stream. The humid feed stream from an incoming gas stream from an industrial process can be hot or made hotter through an economical amount of compression. A hydrophilic membrane can be operated more efficiently at an appropriate temperature and corresponding water vapor pressure. The water vapor may be subsequently removed by several techniques that include compression knockout, condensation, drying, or a combination of these techniques.

Accordingly, in one embodiment is provided a system for separation of an incoming gas stream, the system comprising:
a sweep module comprising water;
a heat transfer module configured to heat the water in the sweep module to produce a sweep stream comprising water vapor, wherein the water is heated using heat derived from the incoming gas stream or a stream derived therefrom; and
a membrane separation module comprising a hydrophilic membrane that partitions a feed side from a permeate side, wherein the membrane separation module is configured to:
receive a humid feed stream on the feed side, wherein the humid feed stream comprises a gas that is permeable through the hydrophilic membrane, and a gas that is substantially impermeable through the hydrophilic membrane;
receive the sweep stream on the permeate side; and
pass the permeable gas through the hydrophilic membrane from the feed side to the permeate side, thereby combining the permeable gas with the sweep stream,
wherein the system is configured to produce a retentate stream that exits the feed side and is depleted in the permeable gas relative to an amount of the permeable gas in the feed stream.

In some embodiments of the foregoing system, the humid feed stream is derived from the incoming gas stream.

In other embodiments of the foregoing system, the permeable gas in the humid feed stream comes into the system with the incoming gas stream.

In more embodiments of the foregoing system, the incoming gas stream is processed to produce the humid feed stream.

In other embodiments of the foregoing system, the sweep stream further comprises a portion of the retentate stream.

In further embodiments of the foregoing system, the sweep stream further comprises a portion of the permeable gas that passes through the hydrophilic membrane.

In more embodiments of the foregoing system, the humid feed stream and the sweep stream flow in a counter-flow direction in the membrane separation module.

In yet other embodiments of the foregoing system, the permeate side has a vacuum pressure.

In different embodiments of the foregoing system, the sweep stream comprises greater than 99% water vapor.

In further embodiments of the foregoing system, the system further comprises a compressor or blower that is configured to increase a pressure of the incoming gas stream or the humid feed stream.

In other embodiments of the foregoing system, the humid feed stream has a temperature between 60° C. and 180° C.

In still different embodiments of the foregoing system, the permeable gas is CO₂, an olefin, or oxygen.

In other embodiments of the foregoing system, the substantially impermeable gas is N₂ or a paraffin.

In more exemplary embodiments of the foregoing system, the hydrophilic membrane comprises a polymer material incorporating a functionality that reversibly interacts with the permeable gas.

In some other embodiments of the foregoing system, the functionality comprises silver cations that reversibly interact with an olefin.

In other embodiments of the foregoing system, the functionality comprises an imidazole-based functionality or amine-based functionality that reversibly interacts with CO₂.

In still more embodiments of the foregoing system, the system comprises a plurality of membrane separation steps.

In other embodiments of the foregoing system, the system comprises a plurality of membrane separation stages.

In some embodiments of the foregoing system, the sweep module and the heat transfer module are integrated in a vessel or housing.

In more embodiments of the foregoing system, the sweep module and the heat transfer module are connected through a conduit.

In related embodiments is provided a method for separation of an incoming gas stream, the method comprising:
using heat from the incoming gas stream or a stream derived therefrom, heating water in a sweep module to produce a sweep stream comprising water vapor;
providing a membrane separation module comprising a hydrophilic membrane that partitions a feed side from a permeate side;
feeding a humid feed stream to the feed side, wherein the humid feed stream comprises a gas that is permeable through the hydrophilic membrane, and a gas that is substantially impermeable through the hydrophilic membrane
feeding the sweep stream to the permeate side;
passing the permeable gas through the hydrophilic membrane from the feed side to the permeate side, thereby combining the permeable gas with the sweep stream; and
producing a retentate stream that exits the feed side and is depleted in the permeable gas relative to an amount of the permeable gas in the feed stream.

In some embodiments of the method, the humid feed stream is derived from the incoming gas stream.

In other embodiments of the foregoing method, the permeable gas in the humid feed stream comes into the system with the incoming gas stream.

In more embodiments of the foregoing method, the incoming gas stream is processed to produce the humid feed stream.

In yet other embodiments of the foregoing method, the sweep stream further comprises a portion of the retentate stream.

In more different embodiments of the foregoing method, the sweep stream further comprises a portion of the permeable gas that passes through the hydrophilic membrane.

In other different embodiments of the foregoing method, the humid feed stream and the sweep stream flow in a counter-flow direction in the membrane separation module.

In further embodiments of the foregoing method, the permeate side has a vacuum pressure.

In different other embodiments of the foregoing method, the sweep stream comprises greater than 99% water vapor.

In other embodiments of the foregoing method, the system further comprises a compressor or blower that is configured to increase a pressure of the incoming gas stream or the humid feed stream.

In more further embodiments of the foregoing method, the humid feed stream has a temperature between 60° C. and 180° C.

In other embodiments of the foregoing method, the permeable gas is CO₂, an olefin, or oxygen.

In some different embodiments of the foregoing method, the substantially impermeable gas is N₂ or a paraffin.

In yet other embodiments of the foregoing method, the hydrophilic membrane comprises a polymer material incorporating a functionality that reversibly interacts with the permeable gas.

In different embodiments of the foregoing method, the functionality comprises silver cations that reversibly interact with an olefin.

In some specific embodiments of the foregoing method, the functionality comprises an imidazole-based functionality or amine-based functionality that reversibly interacts with CO₂.

In more different embodiments of the foregoing method, the system comprises a plurality of membrane separation steps.

In some other embodiments of the foregoing method, the system comprises a plurality of membrane separation stages.

In still other embodiments of the foregoing method, the sweep module and the heat transfer module are integrated in a vessel or housing.

In more embodiments of the foregoing method, the sweep module and the heat transfer module are connected through a conduit.

This summary of the invention has introduced aspects and some of the embodiments of the invention and is not intended to be limiting. As used herein, an aspect is a defining characteristic of the invention as may be recited in an independent claim and further disclosed in the detailed description. An embodiment may be viewed as a variation, or one implementation of an aspect as may be recited in a dependent claim and further disclosed in the detailed description. Certain exemplary embodiments are described herein and are only for purposes of illustrating the invention and should not be interpreted as limiting the scope of the invention. Alternate embodiments, including certain modifications, combinations, and improvements of the described embodiments will occur to those skilled in the art and all such alternate embodiments are within the scope of the invention.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. In addition, use of “a” or “an” are employed to describe elements and components described herein. This is done merely for convenience and for a general sense of the scope of the invention. This description should be read to include one or at least one; the singular also includes the plural unless it is obvious that it is meant otherwise.

### DESCRIPTION OF THE DRAWINGS

FIG. 1 shows an example of an integrated membrane separation unit (1) consistent with the present disclosure comprising connected modules including a membrane module (2) comprising a hydrophilic membrane, a heat transfer module (4), and a sweep module (3) comprising water and water vapor therefrom.

FIG. 2a shows an example of an integrated membrane separation unit (1) consistent with one or more embodiments of the present disclosure further comprising a compressor or blower (11), an incoming gas stream (10), and a combined stream control module (15) that can control a vacuum pressure upstream at the permeate side of the membrane module (2).

FIG. 2b shows an example of an integrated membrane separation unit (1) consistent with one or more embodiments of the present disclosure further comprising a portion control module (13) that can deliver a portion (7b) of a retentate stream (7) to the sweep module (3).

FIG. 3a shows an example of an integrated membrane separation unit (1) consistent with one or more embodiments of the present disclosure as a part of a two-stage separation process comprising a second separation module (14), which can increase the concentration of the permeable component in a product stream (8).

FIG. 3b shows an example of an integrated membrane separation unit (1) consistent with one or more embodiments of the present disclosure as a part of the two-stage separation process further comprising passing the humid feed stream (5) through a humidifier (3a) to increase the level of humidity.

FIG. 4a shows an example of an integrated membrane separation unit (1) consistent with one or more embodiments of the present disclosure further as a part of a two-step two-stage separation process additionally comprising a second separation module (16), which can increase the recovery of the permeable component compared to the two-stage separation process embodied in FIG. 3a and FIG. 3b.

FIG. 4b shows an example of an integrated membrane separation unit (1) consistent with one or more embodiments of the present disclosure as a part of a two-step two-stage separation process additionally comprising passing a part (5a) of the humid feed stream (5) through a humidifier (3a) to increase the level of humidity, where the humidifier (3a) comprises an additional heat transfer module (4b) to transfer heat from the humid feed stream (5) and maintain a temperature of the water in the humidifier (3a).

FIG. 5 shows an example of the systems and methods described herein where a slip stream is taken from the permeate and recycled back through a water saturation step and into the permeate side of the membrane.

FIG. 6 shows an example of operation of the systems and methods described herein showing significantly increased permeance (top) and a CO₂/N₂ selectivity (bottom) that was maintained out to higher stage cut for a hydrophilic membrane using the integrated membrane separation with a sweep stream comprising water vapor in Example 1.

FIG. 7 shows an example of operation of the systems and methods described herein showing higher CO₂ permeance (top) at the lower pressure-ratio of 7 using the integrated separation unit with a hydrophilic membrane in Example 2, where a retentate composition that was less than 2% was achieved at the higher pressure-ratio of 14 at high stage-cut and represented greater than 90% recovery of the permeable component (bottom).

FIG. 8 shows an example of operation of the systems and methods described herein showing a CO₂ permeance (top) that significantly increased with stage cut using a hydrophilic membrane comprising a fluorinated ionomer in Example 3, where a less variable CO₂/N₂ selectivity (bottom) was extended out to higher stage-cut using the integrated membrane separation unit and a sweep stream comprising water vapor.

FIG. 9 shows an example of operation of the systems and methods described herein showing that there was an increase in the permeance (top) at up to 17% at the highest stage cut using a non-hydrophilic membrane in the integrated membrane separation unit in Example 4, where the CO₂/N₂ selectivity (bottom) had dropped by 20%.

### DETAILED DESCRIPTION

The present disclosure uses an integrated membrane separation unit comprising modules that include: a membrane separation module comprising a hydrophilic membrane, a heat transfer module, and a sweep module comprising water and water vapor derived therefrom. The membrane separation module has a feed side, a permeate side, and is configured to receive a part or substantially all (e.g., 100%) of a humid feed stream comprising an incoming gas stream at the feed side comprising a concentration of a permeable component in a gas mixture. The membrane separation module is also configured to receive a sweep stream comprising water vapor at the permeate side. The hydrophilic membrane isolates the feed side from the permeate side and is configured to separate a part or all of the humid feed stream into a retentate stream that exits the feed side having a lower concentration of the permeable component, and a permeate stream at the permeate side having a higher concentration of the permeable component. The permeate stream is combined with the sweep stream to form a combined stream that exits the permeate side. The sweep module is configured to supply the sweep stream comprising water vapor to the permeate side of the membrane module. The heat transfer module is configured to pass an incoming gas stream or the humid feed stream and maintain a temperature of the water through heat transfer from the incoming gas stream or the humid feed stream to the water. Accordingly, the partial pressure of the water vapor in the sweep stream can be advantageously high (i.e., ≥0.2 atm), and may be maintained in certain embodiments without additional energy input using the integrated membrane separation unit.

In some embodiments, the membrane separation module may be configured to receive the sweep stream in a counter flow (i.e., opposite) direction to the feed stream. In some embodiments, the integrated membrane separation unit may be configured so that the partial pressure of the water vapor in the sweep stream is greater than a pressure at the permeate side of the membrane module, and the sweep stream may be greater than 99% water vapor or consisting essentially of steam. In some embodiments, the integrated membrane separation unit may be configured to maintain a vacuum pressure at the permeate side of the membrane separation module. In some embodiments, the integrated membrane separation unit may be configured to deliver a portion of the retentate stream that exits the feed side of the membrane separation module to the sweep module. The portion can be combined with the water vapor in the sweep module to increase the flowrate of the sweep stream. In some embodiments, the integrated membrane separation unit may comprise a compressor or blower that is configured to increase the pressure of the incoming gas stream with a corresponding increase in temperature through adiabatic compression. In some embodiments, the integrated membrane separation unit may be a part of a larger separation process that comprises multiple separation modules and includes two-stage and two-step two-stage separation processes. Therein, the combined stream may be further processed such as to increase the concentration of the permeable component, remove the water vapor, or recycled to other separation modules in the larger separation process. In some embodiments, the retentate stream may be further processed, recycled, or removed from the separation process.

Various membrane separation terms are used herein. As used herein, a “membrane separation module” is a physical housing that incorporates a membrane configured therein that physically separates the module into two sections, a feed side and a permeate side. The membrane separation module and membrane therein can be configured so that a pressure differential can be maintained between the feed side and the permeate side. As used herein, a “pressure ratio” is the ratio of the pressure on the feed side to the pressure on the permeate side. Furthermore, a pressure less than ambient air pressure (i.e., <˜1 atm) may be referred to as a “vacuum pressure”. For example, a feed stream that is flowing and comprises a permeable component in a gas mixture enters the feed side of the membrane separation module at a pressure that is usually greater than ambient air pressure. The “permeable component” selectively permeates through and across the membrane to form a permeate stream at the permeate side of the membrane in the membrane separation module that is at a lower pressure (e.g., vacuum pressure) relative to the pressure of the feed stream but contains a greater concentration of the permeable component. A retentate stream can contain a lower concentration or partial pressure of the permeable component and a greater concentration of a less permeable component. The retentate stream can exit the feed side of the separation module at a lower pressure than the pressure of the feed stream.

As used herein, a “stage cut” is a ratio of the permeate stream to the feed stream as a mole or volume fraction that may be reported as a percentage. A useful stage cut can be between 10% and 60%, or between 20 and 40%. The permeance of a permeable component is a corresponding flux across a membrane that is normalized by the partial pressure difference between the feed side and the permeate side and may be quantified in gas permeance units (GPU, 10⁻⁶ cm³ (STP) cm⁻² s⁻² cmHg⁻¹). A permeance ratio greater than 1 (as defined by the permeance of the permeable component to a less permeable component) is a measure of the separation selectivity and is an indication of how efficiently the membrane can selectively permeate and separate the permeable component from the less permeable component. Useful membranes can have a separation selectivity for a permeable component such as carbon dioxide over a less permeable component such as nitrogen of at least 5, at least 20, or at least 40. The separation selectivity may be observed for a hydrophilic membrane under ideal conditions (i.e., pure gas measurements in the limit of zero pressure-ratio or zero stage-cut).

Useful membranes may include hydrophilic membranes that reversibly absorb and contain water, which may facilitate the permeance of a permeable component that is relatively water-soluble from a feed stream comprising humidity versus a less permeable component. Certain hydrophilic membranes may also incorporate functionality that reversibly interacts with the permeable component in the presence of water, increasing its solubility and permeation. For example, reversible interaction of CO₂ with amine-based functionality, in some instances at temperatures between 60° C. and 100° C., may improve the separation selectivity (separation efficiency) of the hydrophilic membrane under certain operating conditions. Hydrophilic membranes might therefore be economically attractive for large-scale industrial separation and recovery of CO₂ at relatively low pressure (e.g., ≤10 atm). However, a significantly decreased permeance and separation selectivity at high stage cut, which are necessary for recovery of most the permeable component, could offset the advantages of a hydrophilic membrane. For example, U.S. patent application Ser. No. 17/276,639 is incorporated herein by reference in its entirety and discloses delivering a liquid water sweep at up to 60° C. to the permeate side of pressure vessel. The liquid water sweep was used to increase water vapor pressure and humidify a hydrophilic membrane therein for improved permeation and selectivity performance at high pressures and stage cut.

As used herein, a “system” can include an integrated separation module. As used herein, the term “substantially impermeable” means that the component does not substantially permeate through the membrane, e.g., other than through defects in the membrane. In some cases, the rate of permeation of the substantially impermeable gas is at least about 5, at least about 10, at least about 50, at least about 100, at least about 500, at least about 1000, or at least about 10000 times less than the rate of permeation of the permeable gas through the membrane.

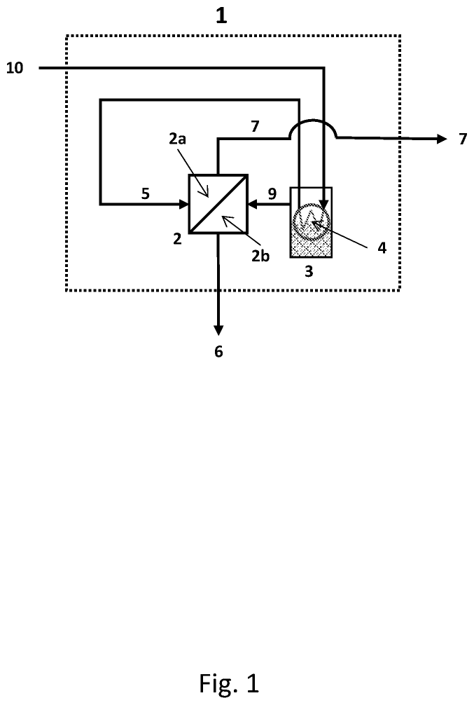

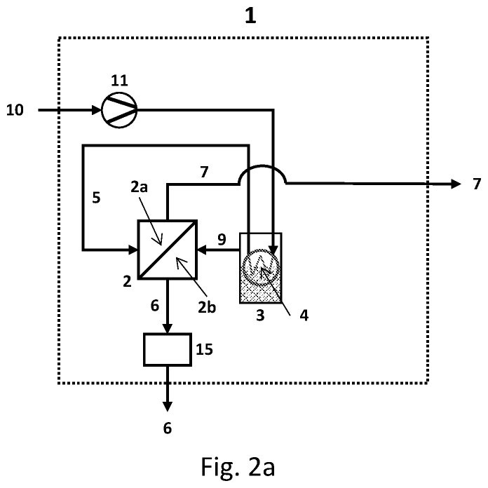

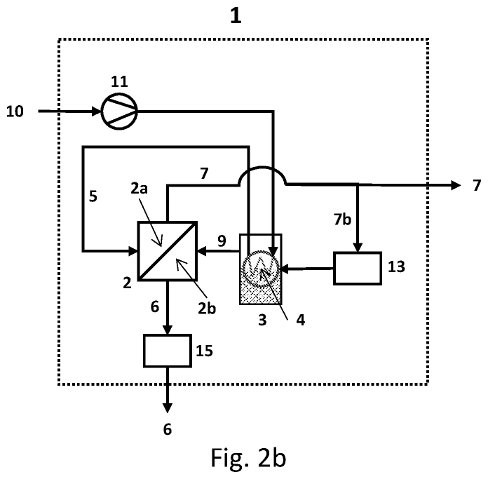

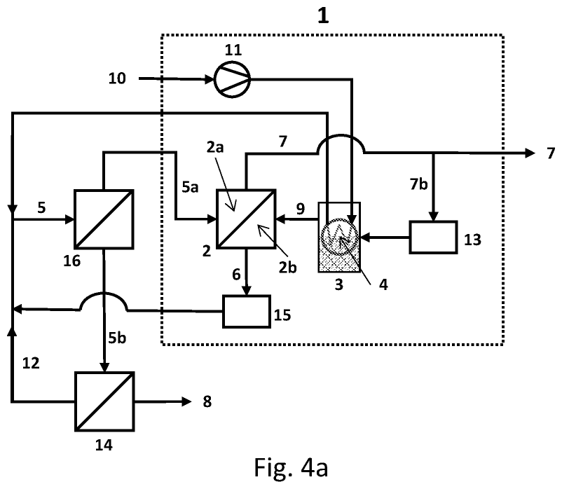

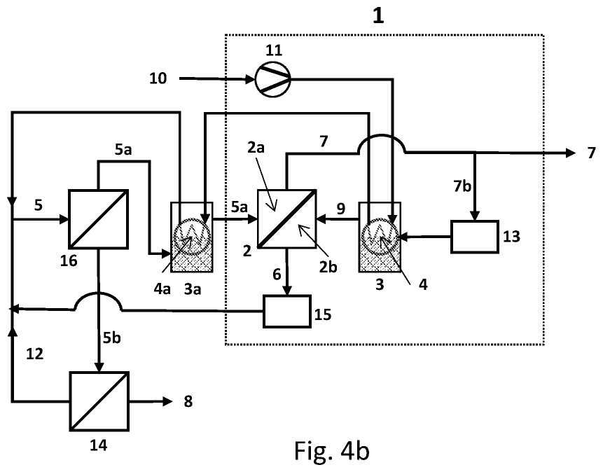

The embodiment of the present disclosure shown in FIG. 1 shows the components of the integrated membrane separation unit (1), which may be a single-stage membrane separation. FIG. 2a through FIG. 4b show more complex embodiments comprising the integrated membrane separation unit (1) that may be connected to additional separation modules. In some embodiments, the integrated membrane separation unit (1) comprises at least three connected modules including a membrane separation module (2) comprising a hydrophilic membrane, a sweep module (3) comprising water and water vapor, and a heat transfer module (4). The membrane separation module (2) can have a feed side (2a) and a permeate side (2b), and can be configured to receive 100% (i.e., FIG. 1 through FIG. 3b) or a part (i.e., 5a in FIG. 4a, and FIG. 4b) of a humid feed stream (5). The humid feed stream can comprise an incoming gas stream (10) comprising a concentration of a permeable component in a gas mixture at the feed side (2a). The membrane module can be configured to receive a sweep stream (9) comprising water vapor at the permeate side (2b). The design of the membrane separation module (2) and form factor of the membrane configured therein can include a flat sheet membrane, a spiral-wound flat sheet membrane, or a hollow fiber membrane.

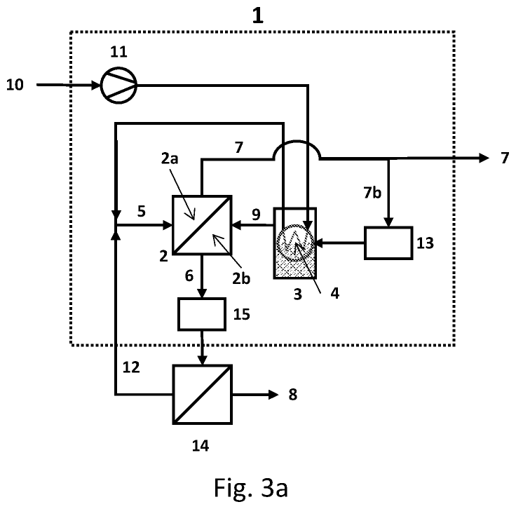

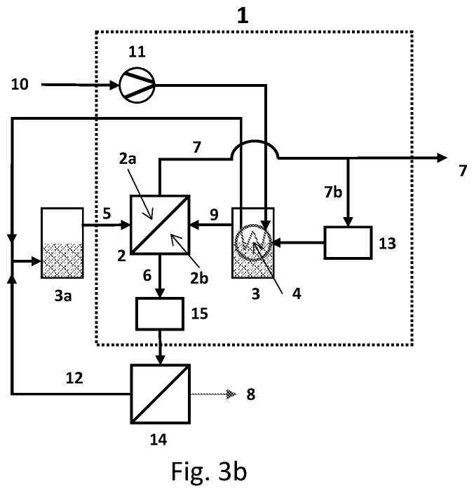

An incoming gas stream (10) may contain humidity in addition to a concentration of a permeable component such as carbon dioxide (CO₂) in a gas mixture. In some embodiments, humidity may be added to the incoming gas stream (10) as necessary to form the humid feed stream (5). Humidity may be added with the use of a humidifier comprising water and water vapor and may be added before or after the heat transfer module (4) and before the membrane separation module (2). In some embodiments (e.g., FIG. 2a, FIG. 2b, FIG. 3a, and FIG. 4a, the incoming gas stream (10) may be from an industrial process. For example, the incoming gas stream (10) may contain about 20% to about 24% CO₂ and water vapor in mostly nitrogen and may originate from the production of hydrogen such as from steam methane reforming (SMR). Alternatively, the incoming gas stream (10) may be a byproduct of cement or steel manufacturing and may contain CO₂ up to approximately 25% and water vapor in mostly nitrogen. The incoming gas stream (10) may also be a pre- or post-combustion flue gas from the combustion of hydrocarbons such as for electricity generation and contain up to about 15% CO₂ and water vapor in mostly nitrogen with some residual oxygen. In some embodiments, the incoming gas stream (10) may have a pressure that is greater than the ambient air pressure and may have a temperature of at least 60° C. The pressure of the incoming gas stream (10) may be increased using a compressor or blower (11) as shown in FIG. 2a through FIG. 4b. For example, the pressure may be increased up to about 10 atm with a corresponding increase in temperature from 60° C. up to about 180° C., resulting from adiabatic compression. The pressure and temperature may be determined at least in part by the desired performance of the hydrophilic membrane in the integrated membrane separation unit (1) and/or the performance and overall economics of a separation process.

The hydrophilic membrane in the membrane separation module (2) can isolate the feed side (2a) from the permeate side (2b) and be configured to separate a part (i.e., 5a in FIG. 4a, and FIG. 4b) or 100% of the humid feed stream (5) (e.g., FIG. 1 through FIG. 3b) into a retentate stream (7) that exits the feed side (2a) and has a lower concentration of the permeable component, and a permeate stream at the permeate side (2b) that has a higher concentration of the permeable component and is combined with the sweep stream (9) at the permeate side (2b) to form a combined stream (6) that then exits the permeate side (2b). The water vapor in the combined stream (6) may be subsequently removed by techniques that include compression knockout, condensation, drying, or a combination of these techniques. In some cases, the combined stream (6) may be further processed to increase the concentration of the permeable component in a larger two-stage separation process as shown in FIG. 3a and FIG. 3b or recycled to the front of an even larger two-step two-stage separation process as shown in FIG. 4a and FIG. 4b.

The sweep module (3) can be configured to supply the sweep stream (9) comprising water vapor to the permeate side (2b) of the membrane separation module (2). In some embodiments, the membrane separation module (2) may be configured to receive the sweep stream (9) in a counter flow (i.e., opposite) direction to the humid feed stream (5), which may further improve the separation efficiency. The water in or from the sweep module (3) can be thermally contacted to the heat transfer module (4). The incoming gas stream (10) or the humid feed stream (5) can pass through the heat transfer module (4) where heat is transferred from the incoming gas stream (10) or the humid feed stream (5) to the water from or in the sweep module (3), and to water vapor that is formed from the water. The heat transfer module (4) may be integrated within, and a part of the sweep module (3) as shown in FIG. 1 through FIG. 4b. In some cases, the heat transfer module (4) may be separate from the sweep module (3) and the water therein connected and thermally contacted to the heat exchange module (4) through means such as conduit pipes. The heat transfer module (4) can be configured to maintain a temperature of the water as it evaporates to form water vapor and a temperature of the sweep stream (9) comprising water vapor in the sweep module (3). The water may be periodically replenished as necessary. Additional water added to the sweep module (3) as it is consumed.

In embodiments shown in FIG. 2a through FIG. 4b, the integrated membrane separation unit (1) may be configured to maintain a vacuum pressure at the permeate side (2b) of the membrane module (2). The vacuum pressure may be any pressure less than ambient air pressure and the integrated membrane separation unit (1) may comprise a combined stream control module (15) that can control a vacuum pressure upstream at the permeate side (2b) and may increase a downstream pressure of the combined stream (6). Accordingly, the combined stream control module (15) can comprise a vacuum pump with a compressor, and/or may comprise a vacuum pump that also has compression capability (e.g., a diaphragm pump). A vacuum pressure of 0.14 to 0.2 psia may be result in a suitable pressure ratio of between 5 to 20 for the humid feed stream (5) or portion (5a) to the combined stream (6) and the performance of the membrane separation unit (1). In some embodiments, the temperature of the water may be sufficiently high so that the partial pressure of the water vapor in the sweep stream (9) is greater than the total pressure at the permeate side of the membrane separation module (2), and the sweep stream (9) may be greater than 99% water vapor or consist essentially of steam.

In embodiments shown in FIG. 2b through FIG. 4b, the integrated membrane separation unit (1) may be configured to deliver a portion (7b) of the retentate stream (7) that exits the feed side (2a) to the sweep module (3). The portion (7b) may be from 1% to 50% of the humid feed stream (5) or a portion thereof (5a) (e.g., 1% to 25%) so as not to substantially dilute the permeable component in the combined stream (6) with a less permeable component. The portion (7b) may be reduced in pressure and delivered to the sweep module (3) through use of a portion control module (13), which may comprise a bleed valve or a pressure regulator. The portion (7b) can be combined with the water vapor in the sweep module (3) to form the sweep stream (9) comprising water vapor and further increase the flowrate and recovery of the permeable component.

In some embodiments (e.g., as shown in FIG. 3a and FIG. 3b), the membrane separation unit (1) may be a component of a larger two-stage separation process comprising an additional separation module (14), which can help increase the concentration of the permeable component in a product stream (8). Therein, the additional separation module (14) is configured to separate the combined stream (6) into a product stream (8) and a second retentate stream (12) that may be recycled and merged with the humid feed stream (5) prior to the humid feed stream (5) being received in the membrane module (2). In some embodiments (e.g., FIG. 3b) the second retentate stream (12) may be merged with the incoming gas stream (10) and then passed through a humidifier (3a) comprising water and water vapor to add humidity or increase the level of humidity and form the humid feed stream (5) before being received in the membrane separation module (2). The additional separation module (14) can comprise a membrane that can selectively permeate the permeable component in the combined stream (6). In some embodiments, the additional separation module (14) can comprise other CO₂ separation processes that include a gas-liquid contactor, which may incorporate amine scrubbing.

In some embodiments (e.g., as shown in FIG. 4a and FIG. 4b), the integrated membrane separation unit (1) may be a part of a larger two-step two-stage separation process. This can further increase the recovery of the permeable component versus the two-stage separation process shown in FIG. 3a and FIG. 3b. The two-step two-stage separation process comprises a second membrane separation module (16) and incorporates a membrane that can selectively permeate the permeable component. The second membrane separation module (16) is upstream of the membrane separation module (2) and is configured to receive substantially all of the humid feed stream (5) and separate it into a third retentate stream and a second permeate stream (5b). Accordingly, the membrane module (2) in the integrated membrane separation unit (1) receives a part (5a) of the humid feed stream (5) as the third retentate stream. The portion (5a) also comprises humidity and in some embodiments, (e.g., FIG. 4b) the third retentate stream may be passed through a humidifier (3a) comprising water and water vapor to add humidity or increase the level of humidity in the portion (5a). The humidifier (3a) may also comprise an additional heat transfer module (4b) to transfer heat from the incoming gas stream (10) or the humid feed stream (5) to the water and maintain a temperature of the water in the humidifier (3a). The portion (5a) can be between 40% and 90% or between 60% to 80% of the humid feed stream (5), corresponding to stage cuts between 60% and 10% or between 40% to 20%, respectively. The additional separation module (14) can be configured to receive and separate the second permeate stream (5b) into a product stream (8) and a second retentate stream (12). Therein, both the second retentate stream (12) and the combined stream (6) may be merged with the incoming gas stream (10) or the humid feed stream (5) prior to the humid feed stream (5) being received in the second membrane separation module (16).

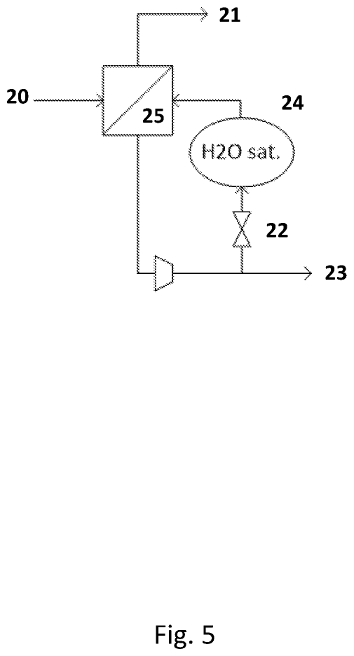

In some instances, the systems and methods described herein can use a partial permeate sweep configuration. As shown in FIG. 5 for a single stage having a feed 20 and producing a retentate 21, a slip stream 22 is taken from the permeate 23 and recycled back through a water saturation step 24 and into the permeate side of the membrane 25. Like the retentate sweep embodiments, this can be operated with permeate vacuum and helps with humiditifaction. Here, the sweep stream (i.e., being under low pressure and high temperature) can hold a significant amount of water in the vapor phase. When recycling the retentate, the CO₂ concentration is very low, leading to increased driving force. However, to achieve effective humidification, this stream can be of a comparable size to the permeate, thus diluting it. This configuration described in FIG. 5 is an option to remedy this issue, as the sweep stream can have a higher CO₂ concentration (e.g., the same dry basis concentration as the permeate at steady state).

A separation process incorporating the integrated membrane separation unit (1) may be performed with any hydrophilic membrane in the membrane separation module (2) that reversibly absorbs and contains water, including liquid water, and is capable of selectively permeating a permeable component that includes CO₂, an olefin, or oxygen from a gas mixture. The membrane may be a composite membrane comprising or consisting of multiple layers that include a gas separation layer that is hydrophilic, a gutter layer, and a porous support. The porous support may have a form factor that includes a flat sheet, a spiral-wound flat sheet, or a hollow fiber. A composite membrane on a hollow-fiber porous-support may be more easily configured in membrane separation module (2) for a counter-flow mode of operation, wherein the feed and permeate gases flow in opposite directions along the length of the hollow fiber. Suitable materials for a hollow fiber can include polyamide, polysulfone, polythersulfone, polyvinylidine fluoride (PVDF), and polyether ether ketone (PEEK).

The gas separation layer can incorporate a polymer material that is hydrophilic (e.g., a hydrogel) that can be formed into thin films. Examples of hydrophilic polymer materials that may selectively permeate CO₂ or oxygen from a gas mixture include polyvinyl alcohol, polyethylene oxide, polypropylene oxide, and polyimides. Ionomers are hydrophilic polymer materials that contain ionic functionality and may be formed into thin films. Ionomers that are fluorinated may be useful as a hydrophilic polymer material in the gas separation layer of a composite membrane for CO₂ separation as disclosed in PCT Application Serial No: US2019/024517, which is incorporated herein by reference in its entirety. A composite membrane incorporating a fluorinated ionomer can have a CO₂ permeance greater than 1000 GPU and selectivity over nitrogen of at least 40. Examples of fluorinated ionomers include Nafion® (Chemours, Wilmington DE) and Aquivion® (Solvay, Houston TX). Fluorinated (and non-fluorinated) ionomers that comprise silver cations may also be used for separation of olefin-paraffin streams in refinery processes (wherein the permeable component is an olefin) or for separation of oxygen from nitrogen

A gas separation layer may comprise a hydrophilic polymer material that contains functionality that reversibly interacts with the permeable component, increasing its permeability. The functionality can comprise silver cations such as silver sulfonate for separation of olefin-paraffin streams. In some cases, the functionality can be amine-based or imidazole-based for separation of CO₂. Reversible interaction of the amine-based or imidazole-based functionality with CO₂ in the presence of water (e.g., at temperatures between 60° C. and 100° C.) may increase the CO₂ permeance and the gas separation selectivity. For example, a hydrophilic membrane incorporating an amine-containing polymer material that may be a suitable hydrophilic membrane for the membrane module (2) is described in U.S. Pat. No. 10,835,847, which is incorporated herein by reference. Other hydrophilic polymer materials that may be suitable and incorporate amine-based functionality include homopolymers and copolymers comprising, for example, a “vinylamine”, “allylamine”, or “ethyleneimine” repeat unit. Some of these polymer materials are commercially available or may be prepared through homo-polymerization and copolymerization of monomers such as N-vinylformamide or related monomers that are precursors to a repeat unit having amine-based functionality. The hydrophilic polymer material may also comprise amine- or imidazole-based functionality that also carries a positive charge such as quaternary ammonium or imidazolium groups, respectively. An example of the latter includes poly(imidazole-imidazolium)-based polymers that can include methylated polybenzimidazole polymers.

### EXAMPLES

### Example 1

### Integrated Membrane Separation Unit and Separation of CO₂ Using a Hydrophilic Membrane with and without a Sweep Stream Comprising Water Vapor

The integrated membrane separation unit was assembled with a 4-port membrane separation module having an L/D ratio of approximately 45 and was configured for counter-flow operation having inlets for a feed stream comprising humidity and a sweep stream comprising water vapor, and outlets for a retentate stream and a combined stream or permeate stream (no sweep stream). The hydrophilic membrane configured in the membrane separation module comprised a multi-layer composite membrane (100 cm²) on hollow fibers having a gas separation layer (˜0.3 μm) from a poly(imidazole-imidazolium)-based polymer and associated hydroxide counter-anion. Using humidified pure gases, the membrane had a CO₂ permeance of approximately 600 GPU and a CO₂/N₂ selectivity of 110 in the limit of zero pressure-ratio or zero stage-cut.

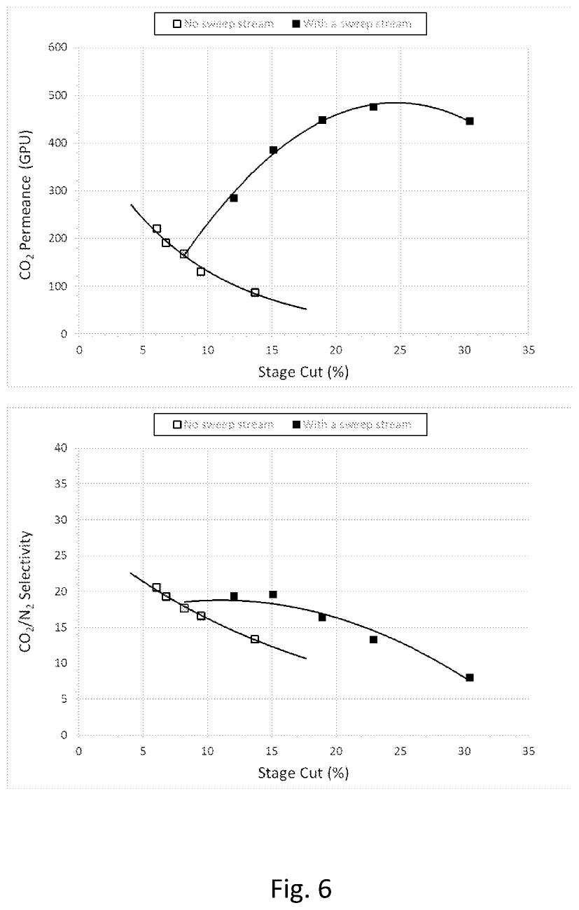

A feed stream comprising humidity and a concentration of permeable component in a gas stream was simulated by passing a 12% CO₂ in nitrogen mixture at 100 to 500 mL/min through the lumen of a first Perma Pure™ humidifier having liquid water on the shell side of a Nafion™ hollow tube. A sweep module and sweep stream comprising water vapor were simulated by diverting a portion of the retentate stream through a needle valve and then through the lumen of a second Perma Pure™ humidifier. The outlet of the first humidifier was connected to the feed stream inlet of the membrane separation module while the outlet of the second humidifier was connected to the sweep stream inlet. Both humidifiers and the membrane separation module were immersed in a 60° C. water bath to simulate a heat transfer module and transfer of heat from the feed stream to the water. A pressure ratio of 14 for the feed stream (2.8 atm) to the combined stream or a permeate stream (0.2 atm) was maintained with adjustments to a flow rate of the feed stream (no sweep stream) or needle valve (with a sweep stream) to change the stage cut. Table 1 shows the operational parameters and the performance of the integrated membrane separation unit. FIG. 6 shows a significantly increased permeance at higher stage cut and a CO₂/N₂ selectivity that was maintained out to higher stage cut with a sweep stream comprising water vapor.

TABLE 1

| Feed | | Permeate or Combined Stream | | | | | Retentate | Stage |
|---|---|---|---|---|---|---|---|---|
| Stream | Sweep | Flowrate | % | Total Flux | CO₂ | CO₂/ | Stream | Cut |
| (mL/min) | Stream | (mL/min) | CO₂ | (mole/h/m²) | GPU | N₂ | (% CO₂) | (%) |
| 100 | No | 13.7 | 45.6 | 3.3 | 87 | 13 | 5.6 | 13.7 |
| 200 | No | 19.0 | 52.6 | 4.6 | 130 | 17 | 6.9 | 9.5 |
| 300 | No | 24.6 | 56.0 | 6.0 | 170 | 18 | 8.0 | 8.2 |
| 400 | No | 27.1 | 58.2 | 6.6 | 190 | 19 | 8.3 | 6.8 |
| 500 | No | 30.2 | 59.4 | 7.4 | 220 | 21 | 8.8 | 6.0 |
| 300 | Yes | 24.6 | 56.0 | 6.0 | 170 | 18 | 8.0 | 8.2 |
| 300 | Yes | 36.1 | 53.1 | 8.8 | 290 | 19 | 5.9 | 12.0 |
| 300 | Yes | 45.3 | 49.7 | 11.0 | 390 | 20 | 4.6 | 15.1 |
| 300 | Yes | 56.8 | 44.5 | 13.8 | 450 | 17 | 3.9 | 18.9 |
| 300 | Yes | 68.7 | 40.0 | 16.7 | 480 | 13 | 3.6 | 22.9 |
| 300 | Yes | 91.2 | 30.4 | 22.2 | 450 | 8 | 3.3 | 30.4 |

### Example 2

### Integrated Membrane Separation Unit and Separation of CO₂ at Varied Pressure Ratio Using a Hydrophilic Membrane with and without a Sweep Stream Comprising Water Vapor

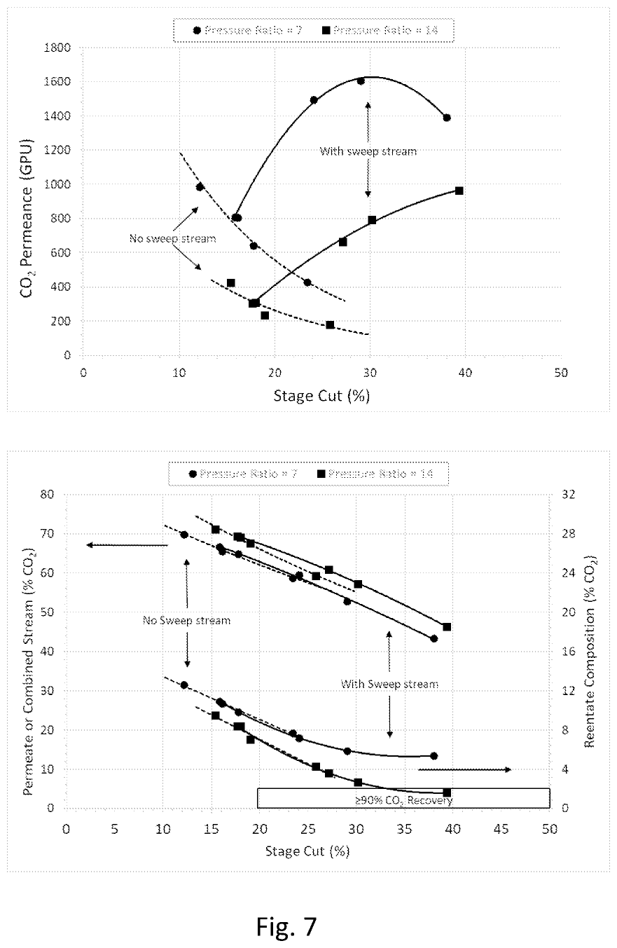

The integrated membrane separation unit as described in Example 1 with membrane separation module therein was configured with a multi-layer composite membrane (100 cm²) on hollow fibers having a gas separation layer (˜60 nm) from a poly(imidazole-imidazolium)-based polymer and associated hydroxide counter-anion. Using humidified pure gases, the membrane had a CO₂ permeance of approximately 2600 GPU and a CO₂/N₂ selectivity of approximately 100 in the limit of zero pressure-ratio or zero stage-cut. A feed stream comprising humidity and a concentration of permeable component in a gas stream was simulated as described in Example 1 using a 20% CO₂ in nitrogen mixture. The sweep module, heat transfer module, and sweep stream comprising water vapor were also simulated as described. A pressure ratio of 7 or 14 for the feed stream (1.4 or 2.8 atm) to the combined stream or permeate stream (0.2 atm) was maintained with adjustments to a flow rate of the feed stream (no sweep stream) or needle valve (with a sweep stream) to change the stage cut. Table 2 shows the operational parameters and the performance of the integrated membrane separation unit at the two pressure ratios. FIG. 7 shows higher CO₂ permeance at the lower pressure-ratio of 7. However, a retentate composition that was less than 2% was achieved at the higher pressure-ratio of 14 at high stage-cut with the sweep stream and represented great than 90% recovery of the permeable component.

TABLE 2

| Feed | | | Permeate or Combined Stream | | | | | Retentate | Stage |
|---|---|---|---|---|---|---|---|---|---|
| Stream | Pres. | Sweep | Flowrate | % | Total Flux | CO₂ | CO₂/ | Stream | Cut |
| (mL/min) | Ratio | Stream | (mL/min) | CO₂ | (mole/h/m²) | GPU | N₂ | (% CO₂) | (%) |
| 100 | 7 | No | 23.4 | 58.7 | 5.7 | 430 | 22 | 7.7 | 23.4 |
| 200 | 7 | No | 35.6 | 64.9 | 8.7 | 640 | 25 | 9.8 | 17.8 |
| 300 | 7 | No | 48.4 | 65.5 | 11.8 | 810 | 24 | 10.7 | 16.1 |
| 500 | 7 | No | 60.9 | 69.8 | 14.8 | 980 | 26 | 12.6 | 12.2 |
| 300 | 7 | Yes | 47.6 | 66.6 | 11.6 | 810 | 25 | 10.9 | 15.9 |
| 300 | 7 | Yes | 72.3 | 59.5 | 17.6 | 1500 | 25 | 7.2 | 24.1 |
| 300 | 7 | Yes | 87.1 | 52.8 | 21.2 | 1610 | 19 | 5.9 | 29.0 |
| 300 | 7 | Yes | 114.0 | 43.3 | 27.8 | 1390 | 10 | 5.4 | 38.0 |
| 100 | 14 | No | 25.8 | 59.3 | 6.3 | 180 | 19 | 4.3 | 25.8 |
| 200 | 14 | No | 38.0 | 67.6 | 9.3 | 240 | 22 | 7.0 | 19.0 |
| 300 | 14 | No | 54.0 | 69.1 | 13.2 | 310 | 21 | 8.4 | 18.0 |
| 500 | 14 | No | 77.1 | 71.2 | 18.8 | 430 | 21 | 9.5 | 15.4 |
| 300 | 14 | Yes | 53.1 | 69.4 | 12.9 | 310 | 21 | 8.4 | 17.7 |
| 300 | 14 | Yes | 81.4 | 60.9 | 19.8 | 670 | 24 | 3.6 | 27.1 |
| 300 | 14 | Yes | 90.5 | 57.2 | 22.1 | 800 | 23 | 2.7 | 30.2 |
| 500 | 14 | Yes | 118.0 | 46.4 | 28.8 | 960 | 17 | 1.6 | 39.3 |

### Example 3

### Integrated Membrane Separation Unit and Separation of CO₂ with and without a Sweep Stream Comprising Water Vapor and Using a Hydrophilic Membrane Incorporating a Fluorinated Ionomer

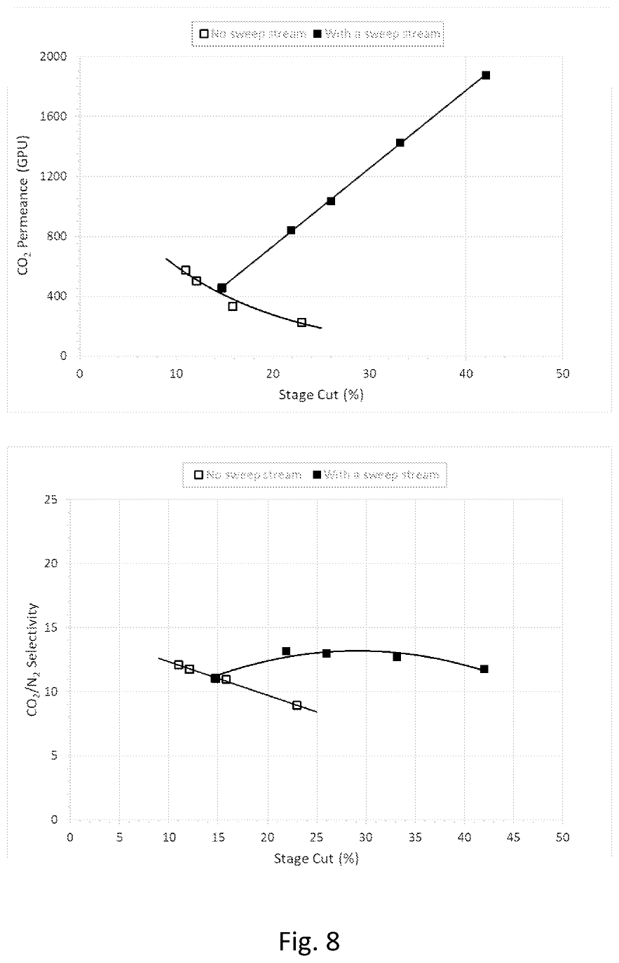

The integrated membrane separation unit as described in Example 1 and membrane separation module therein was configured with a multi-layer composite membrane (96 cm²) on hollow fibers having a gas separation layer (˜0.11 μm) from a fluorinated ionomer containing sulfonic acid functionality. Using humidified pure gases, the membrane had a CO₂ permeance of approximately 2000 GPU and a CO₂/N₂ selectivity of approximately 40 in the limit of zero pressure-ratio or zero stage-cut. A feed stream comprising humidity and a concentration of permeable component in a gas stream was simulated as described in Example 1 using a 20% CO₂ in nitrogen mixture. The sweep module, heat transfer module, and sweep stream comprising water vapor were also simulated as described. A pressure ratio of 7 for the feed stream (1.4 atm) to the combined stream or permeate stream (0.2 atm) was maintained with adjustments to a flow rate of the feed stream (no sweep stream) or needle valve (with a sweep stream) to change the stage cut. Table 3 shows the operational parameters and the performance of the integrated membrane separation unit incorporating a fluorinated ionomer. FIG. 8 shows a CO₂ permeance that appeared to linearly increase with stage cut using a sweep stream comprising water vapor and a less variable CO₂/N₂ selectivity appeared to be extended out to higher stage-cut.

TABLE 3

| Feed | | Permeate or Combined Stream | | | | | Retentate | Stage |
|---|---|---|---|---|---|---|---|---|
| Stream | Sweep | Flowrate | % | Total Flux | CO₂ | CO₂/ | Stream | Cut |
| (mL/min) | Stream | (mL/min) | CO₂ | (mole/h/m²) | GPU | N₂ | (% CO₂) | (%) |
| 100 | No | 23.0 | 50.2 | 5.8 | 230 | 9 | 10.4 | 23.0 |
| 200 | No | 31.7 | 56.6 | 8.0 | 330 | 11 | 12.6 | 15.9 |
| 300 | No | 44.2 | 57.5 | 11.2 | 460 | 11 | 13.2 | 14.7 |
| 400 | No | 48.5 | 59.9 | 12.3 | 500 | 12 | 14.3 | 12.1 |
| 500 | No | 54.9 | 61.0 | 13.9 | 570 | 12 | 14.8 | 11.0 |
| 300 | Yes | 44.2 | 57.5 | 11.2 | 460 | 11 | 13.2 | 14.7 |
| 300 | Yes | 65.6 | 54.9 | 16.7 | 840 | 13 | 9.5 | 21.9 |
| 300 | Yes | 77.9 | 52.6 | 19.8 | 1040 | 13 | 8.3 | 26.0 |
| 300 | Yes | 99.3 | 47.5 | 25.2 | 1420 | 13 | 6.0 | 33.1 |
| 300 | Yes | 126.0 | 41.8 | 32.0 | 1880 | 12 | 4.6 | 42.0 |

### Example 4

### Comparative Example Using a Non-Hydrophilic Membrane in the Integrated Membrane Separation Unit

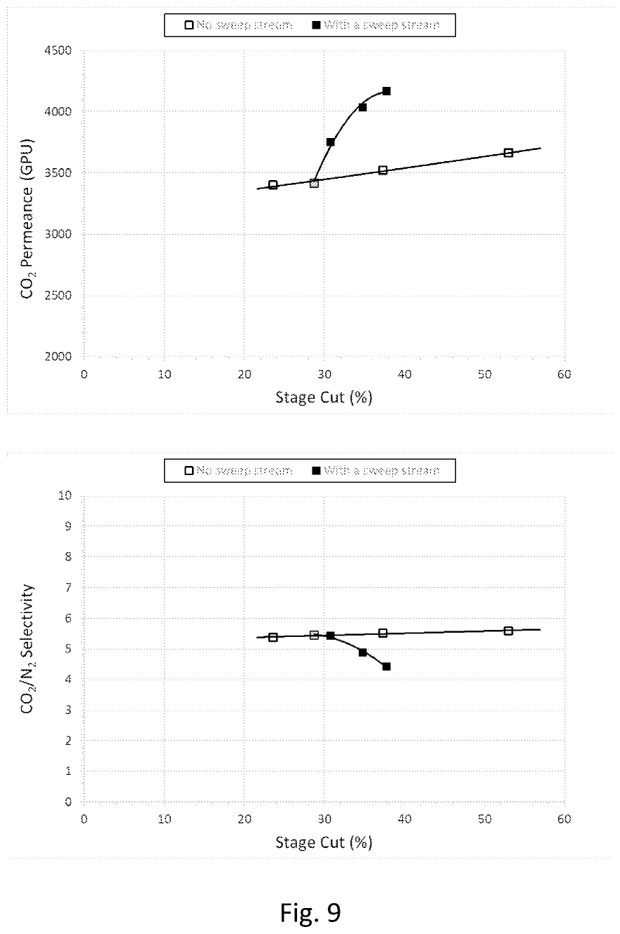

The integrated membrane separation unit as described in Example 1 and a membrane separation module therein was configured with a composite membrane (23 cm²) on hollow fibers having a gas separation layer (˜1.5 μm) from a non-hydrophilic polymer material. Using pure gases, the membrane had a CO₂ permeance of approximately 4700 GPU and a CO₂/N₂ selectivity of approximately 10 in the limit of zero pressure-ratio or zero stage-cut. A feed stream comprising humidity and a concentration of permeable component in a gas stream was simulated as described in Example 1 using a 20% CO₂ in nitrogen mixture. The sweep module, heat transfer module, and sweep stream comprising water vapor were also simulated as described. A pressure ratio of 7 for the feed stream (1.4 atm) to the combined stream or permeate stream (0.2 atm) was maintained with adjustments to a flow rate of the feed stream (no sweep stream) or needle valve (with a sweep stream) to change the stage cut. Table 4 shows the operational parameters and the performance of the membrane incorporating the non-hydrophilic polymer material in the integrated membrane separation unit. FIG. 9 shows that with the sweep stream there was a modest increase in the permeance at up to 17% at the highest stage cut. However, the CO₂/N₂ selectivity had dropped by 20%.

TABLE 4

| Feed | | Permeate or Combined Stream | | | | | Retentate | Stage |
|---|---|---|---|---|---|---|---|---|
| Stream | Sweep | Flowrate | % | Total Flux | CO₂ | CO₂/ | Stream | Cut |
| (mL/min) | Stream | (mL/min) | CO₂ | (mole/h/m²) | GPU | N₂ | (% CO₂) | (%) |
| 200 | No | 106 | 32.6 | 112 | 3660 | 5.6 | 4.4 | 53.0 |
| 300 | No | 112 | 38.7 | 119 | 3520 | 5.5 | 8.0 | 37.3 |
| 400 | No | 115 | 41.8 | 123 | 3420 | 5.4 | 10.3 | 28.8 |
| 500 | No | 118 | 43.4 | 125 | 3400 | 5.4 | 12.0 | 23.6 |
| 400 | Yes | 115 | 41.8 | 122 | 3420 | 5.4 | 10.3 | 28.8 |
| 400 | Yes | 123 | 40.6 | 130 | 3750 | 5.4 | 9.9 | 30.8 |
| 400 | Yes | 139 | 38.1 | 147 | 4040 | 4.9 | 9.7 | 34.8 |
| 400 | Yes | 151 | 35.8 | 160 | 4170 | 4.4 | 9.5 | 37.8 |

1. A system for separation of an incoming gas stream, the system comprising:
a. a sweep module comprising water;
b. a heat transfer module configured to heat the water in the sweep module to produce a sweep stream comprising water vapor, wherein the water is heated using heat derived from the incoming gas stream or a stream derived therefrom; and
c. a membrane separation module comprising a hydrophilic membrane that partitions a feed side from a permeate side, wherein the membrane separation module is configured to:
i. receive a humid feed stream on the feed side, wherein the humid feed stream comprises a gas that is permeable through the hydrophilic membrane, and a gas that is substantially impermeable through the hydrophilic membrane;
ii. receive the sweep stream on the permeate side; and
iii. pass the permeable gas through the hydrophilic membrane from the feed side to the permeate side, thereby combining the permeable gas with the sweep stream,
wherein the system is configured to produce a retentate stream that exits the feed side and is depleted in the permeable gas relative to an amount of the permeable gas in the feed stream.

2. The system of claim 1, wherein;
(a) the humid feed stream is derived from the incoming gas stream-;
(b) the permeable gas in the humid feed stream comes into the system with the incoming gas stream; or
(c) the incoming gas stream is processed to produce the humid feed stream or the sweep stream.

3. (canceled)

4. (canceled)

5. The system of claim 1, wherein the sweep stream further comprises a portion of the retentate stream.

6. The system of claim 1, wherein the sweep stream further comprises a portion of the permeable gas that passes through the hydrophilic membrane.

7. The system of claim 1, wherein the humid feed stream and the sweep stream flow in a counter-flow direction in the membrane separation module.

8. The system of claim 1, wherein the permeate side has a vacuum pressure.

9. The system of claim 1, wherein the sweep stream comprises greater than 99% water vapor.

10. The system of claim 1, wherein the system further comprises a compressor or blower that is configured to increase a pressure of the incoming gas stream or the humid feed stream.

11. The system of claim 1, wherein the humid feed stream has a temperature between 60° C. and 180° C.

12. (canceled)

13. (canceled)

14. The system of claim 1, wherein the hydrophilic membrane comprises a polymer material incorporating a functionality that reversibly interacts with the permeable gas.

15. (canceled)

16. The system of claim 14, wherein the functionality comprises an imidazole-based functionality or amine-based functionality that reversibly interacts with CO₂.

17. The system of claim 1, wherein the system comprises a plurality of membrane separation steps or stages.

18-20. (canceled)

21. A method for separation of an incoming gas stream, the method comprising:
a. using heat from the incoming gas stream or a stream derived therefrom, heating water in a sweep module to produce a sweep stream comprising water vapor;
b. providing a membrane separation module comprising a hydrophilic membrane that partitions a feed side from a permeate side;
c. feeding a humid feed stream to the feed side, wherein the humid feed stream comprises a gas that is permeable through the hydrophilic membrane, and a gas that is substantially impermeable through the hydrophilic membrane
d. feeding the sweep stream to the permeate side;
e. passing the permeable gas through the hydrophilic membrane from the feed side to the permeate side, thereby combining the permeable gas with the sweep stream; and
f. producing a retentate stream that exits the feed side and is depleted in the permeable gas relative to an amount of the permeable gas in the feed stream.

22-24. (canceled)

25. The system of claim 21, wherein the sweep stream further comprises a portion of the retentate stream.

26-36. (canceled)

37. The system of claim 21, wherein the system comprises a plurality of membrane separation steps or stages.

38-40. (canceled)
